(19) United States
(12) Patent Application Publication
(10) Pub. No.: US 2025/0034734 A1
(43) Pub. Date: Jan. 30, 2025

(54) Porous Transport Layer for Use in a Polymer Electrolyte Membrane Electrolyzer, an Electrolyzer Comprising said Porous Transport Layer, a Method for Obtaining Said Porous Transport Layer and a Method for Electrolysing Water Using Said Porous Transport Layer

(71) Applicant: Magneto Special Anodes B.V., Schiedam (NL)

(72) Inventors: Johannes Godfried VOS, Leiden (NL); Matti VAN SCHOONEVELD, Leiden (NL); Adriaan W. JEREMIASSE, Rotterdam (NL)

(73) Assignee: Magneto Special Anodes B.V., Schiedam (NL)

(21) Appl. No.: 18/716,719

(22) PCT Filed: Dec. 16, 2022
(86) PCT No.: PCT/EP2022/086464

§ 371 Date: Jun. 5, 2024

Related U.S. Application Data
(60) Provisional application No. 63/290,724, filed on Dec. 17, 2021.
(60) Provisional application No. 63/306,710, filed on Feb. 4, 2022.

(51) Int. Cl. C25B 13/02; C25B 1/04; C25B 9/23; C25B 13/07; C25B 13/08

(52) U.S. Cl. CPC C25B 13/02; C25B 1/04; C25B 9/23; C25B 13/07; C25B 13/08

(57) ABSTRACT

A Porous Transport Layer for use in a Polymer Electrolyte Membrane electrolyzer, the Porous Transport Layer comprising a substrate and a coating, wherein the coating comprises a non-precious metal coating, an electrolyzer comprising said Porous Transport Layer, a method to obtain said Porous Transport Layer and a method for electrolysing water using said Porous Transport Layer.

Electrolysis is a promising option for carbon-free hydrogen production from renewable and nuclear resources. Electrolysis is the process of using electricity to split water into hydrogen and oxygen. The process of electrolysis is performed in a unit called an electrolyzer. Electrolyzers can range in size from small, appliance-size equipment that is well-suited for small-scale distributed hydrogen production, to large-scale, central production facilities that, for instance, could be directly connected to renewable or other non-greenhouse-gas-emitting forms of electricity production.

### BACKGROUND OF THE TECHNOLOGY

In 2021, the U.S. Department of Energy's (DOE's) has formulated an objective to reduce the costs of clean hydrogen by 80% to $1 per 1 kilogram in 1 decade. The objective of reducing the production of hydrogen to $1 per 1 kilogram in 1 decade is referred to as the hydrogen “1 1 1” initiative. Electrolysis is a leading hydrogen production pathway to achieve this goal.

Hydrogen produced via electrolysis can result in zero greenhouse gas emissions, depending on the source of the electricity used. The source of the required electricity, including its cost and efficiency, as well as emissions resulting from electricity generation, must be considered when evaluating the benefits and economic viability of hydrogen production via electrolysis. In many regions in the world, today's power grid is not ideal for providing the electricity required for electrolysis. The reason for this is the greenhouse gases released during the actual production of the electricity and the amount of fuel required to produce electricity due to the low efficiency of the electricity generation process.

Hydrogen production via electrolysis is being pursued for renewable and nuclear energy options, including wind, solar, hydro and geothermal energy production. These pathways result in virtually zero greenhouse gas and criteria pollutant emissions, provided the electricity that is used for electrolysis is obtained by means of renewable energy sources. Moreover, it is important that the overall production cost for the energy decrease significantly to be competitive with more mature carbon-based pathways such as natural gas reforming.

A promising technology to generate hydrogen is the use of Polymer Electrolyte Membrane (PEM) electrolyzers. In a PEM electrolyzer, the electrolyte is a solid specialty plastic material similar to an ion exchange membrane.

During water electrolysis in a Polymer Electrolyte Membrane electrolyzer, deionized water (H₂O) is split into its constituent parts, hydrogen (H₂) and oxygen (O₂). These constituents are formed, on either side of a solid proton exchange membrane. When a DC voltage is applied to the electrolyzer, water fed to the anode (or oxygen electrode) is oxidized to oxygen and protons, while electrons are released. The protons (H+ ions) pass through the proton exchange membrane to the cathode (or hydrogen electrode), where they meet electrons from the other side of the circuit and are reduced to hydrogen gas.

A key component of any Polymer Electrolyte Membrane electrolyzer is the Porous Transport Layer, or PTL. This Porous Transport Layer provides the electrical contact between bipolar plates on opposite sides of the proton exchange membrane and the proton exchange membrane. Moreover, the Porous Transport Layer facilitates the transport of reactants and products between them.

The Porous Transport Layer is not only a key component, but also an expensive component of a Polymer Electrolyte Membrane electrolyzer.

In view of the above, there is a growing need for improved electrolyzers, which show improved energy efficiency and lifetime. In particular, there appears to be a need for providing improved Porous Transport Layers for a Polymer Electrolyte Membrane electrolyzer.

### SUMMARY OF THE INVENTION

According to a first aspect, the disclosure relates to a Porous Transport Layer for use in a Polymer Electrolyte Membrane electrolyzer, the Porous Transport Layer comprising a substrate and a coating, wherein the coating comprises a non-precious metal coating.

According to a second aspect, the disclosure relates to an electrochemical system comprising a Polymer Electrolyte Membrane electrolyzer, the Polymer Electrolyte Membrane electrolyzer having a first and a second Bipolar Plate, adapted to function as respectively an anode an a cathode during electrolysis, wherein the Bipolar plates are positioned at opposite sides of a proton exchange membrane and wherein the first Bipolar Plate and the second Bipolar Plate are electrically connected to the proton exchange membrane by means of respectively a first and a second Porous Transport Layer, wherein at least one of the first and second Porous Transport Plates, at the surface adapted to contact the proton exchange membrane, is provided with a non-precious metal coating.

According to a third aspect the disclosure relates to a method for obtaining a Porous Transport Layer adapted for use in a Polymer Electrolyte Membrane electrolyzer, the Porous Transport Layer comprises Titanium, wherein the method comprises the step of:
heat treating of the surface of the Porous Transport Plate adapted to contact the proton exchange membrane, to obtain a coating of Titanium Oxide (TiOx) at that surface.

According to a fourth aspect, the disclosure relates to a method for electrolysing water comprising the steps of:
(i) providing a Polymer Electrolyte Membrane water electrolyzer comprising a first and a second Bipolar Plate, adapted to function as respectively an anode an a cathode during electrolysis, a proton exchange membrane and a first and a second Porous Transport Layer to electrically connect the first and second Bipolar Plats with the proton exchange membrane, wherein at least one of the first and a second Bipolar Plates at the surface adapted to contact the proton exchange membrane is provided with a non-precious metal coating;
(ii) contacting the water electrolyzer with water;
(iii) creating an electrical bias between the anode and the cathode; and
(iv) generating hydrogen and/or oxygen.

### BRIEF DESCRIPTION OF THE DRAWINGS

FIG. 1 shows an embodiment of the Porous Transport Plate according to the disclosure, in a stack further comprising Bipolar Plates and a proton exchange membrane;

FIG. 2 shows schematically an apparatus that has been developed to allow the testing of Porous Transport Layers according to the disclosure;

FIG. 3 shows in a diagram the performance during electrolysis of unmodified and modified Titanium Porous Transport Layers at room temperature, expressed as current density at 1.75 V vs Reversible Hydrogen Electrode (RHE); and

FIG. 4 shows in a diagram the performance during electrolysis of unmodified and modified Titanium Porous Transport Layers at room temperature as expressed relative to the initial performance at 1.75 V vs RHE.

### DETAILED DESCRIPTION OF THE INVENTION

The phraseology and terminology used in this disclosure is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. The use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the present disclosure, the term non-precious metal is used. In the context of this text, the precious metals are defined as being part of the following group: Gold, Silver, Platinum, Palladium, Platinum, Ruthenium, Rhodium, Osmium, Iridium, Rhenium, Germanium, Beryllium, Indium, Gallium, Tellurium, Bismuth and Mercury.

In the context of this disclosure, with the term non-precious metal reference is made to a metal that does not belong to the above-mentioned group of precious metals.

Hydrogen (H₂) is an important feedstock for various branches of the chemical industry, such as petrochemicals and semiconductor manufacturing. Moreover, it holds high potential as an agent to make the global energy infrastructure more environmentally sustainable. Hydrogen can serve as energy carrier to replace fossil fuels in a hydrogen economy, and it is also able to reduce CO₂ emissions in energy-intensive applications such as steel and aluminium refining.

The most prominent way of producing hydrogen that is truly ‘green’ is through water electrolysis powered by renewable energy sources. However, water electrolysis suffers from energy inefficiencies due to the difficulty of catalyzing the reaction. Better electrocatalysts are needed to make the process more economically competitive.

The overall reaction in water electrolysis is given by

2H₂O→2H₂+O₂

The process is carried out in either acid or alkaline electrolyzers, where acid electrolyzers use a wet acidic ion exchange membrane as electrolyte, and alkaline electrolyzers use concentrated aqueous base, typically KOH in range of 15-30% mass, as electrolyte with a Zirfon separator.

Acidic systems benefit from compactness, low electrolyte resistance and good gas separation capabilities, which allows them to run at higher current densities of typically 10-30 kA/m2, and makes them more flexible in terms of ramping activity up and down. One of the main disadvantages is the reliance of this type of electrolyzer on iridium as electrocatalyst on the anode, which is an exceedingly rare and therefore expensive element. Alkaline systems rely much less on critical materials, but are bulkier, have higher internal resistances and lower power flexibility.

The overall reaction consists of two electrochemical half reactions, the hydrogen evolution reaction (HER) and oxygen evolution reaction (OER), which are described respectively in acidic and alkaline electrolytes by

4H⁺+4e⁻→2H₃

4H₂O+4e⁻→2H₂+4OH⁻

2H₂O→O₂+4H⁺+4e⁻

4OH⁻→O₂+2H₂O+4e⁻

A promising technology to generate hydrogen is the use of a Polymer Electrolyte Membrane (PEM) electrolyzer.

In a Polymer Electrolyte Membrane electrolyzer, the electrolyte is a solid specialty plastic material similar to an ion exchange membrane. In Polymer Electrolyte Membrane water electrolysis, deionized water (H₂O) is split into its constituent parts, hydrogen (H₂) and oxygen (O₂), on either side of a solid polymer electrolyte membrane.

When a DC voltage is applied to the electrolyzer, water fed to the anode (or oxygen electrode) is oxidized to oxygen and protons, while electrons are released. The protons (H+ ions) pass through the proton exchange membrane to the cathode (or hydrogen electrode), where they meet electrons from the other side of the circuit and are reduced to hydrogen gas.

At the cathode, hydrogen ions combine with electrons from the external circuit to form hydrogen gas.

A Polymer Electrolyte Membrane electrolyzer typically comprises stacks for executing electrolysis, wherein each stack comprises two Bipolar Plates, which form the anode side and the cathode side for the electrolysis. A proton exchange membrane positioned in between the Bipolar Plates and a first and a second Porous Transport Layer. These Porous Transport Layers are a key component of a Polymer Electrolyte Membrane electrolyzer stack.

The first Porous Transport Layer provides the electrical contact between the first Bipolar Plate on the anode side of the stack and proton exchange membrane. The proton exchange membrane is provided with a catalyst layer, therefore it would be more accurate to say that the first Porous Transport Layer provides the electrical contact between the first Bipolar Plate and the catalyst layer on the proton exchange membrane on the anode side of the stack. In the context of this disclosure, when reference is made to electrical contact between the Porous Transport Layer and the proton exchange membrane, it is intended that reference is made to the electrical contact between the Porous Transport Layer and the proton exchange membrane and/or catalyst on the proton exchange membrane.

The second Porous Transport Layer provides the electrical contact between the second Bipolar Plate and the proton exchange membrane on the cathode side of the stack.

The first Porous Transport Layer on the anode side is typically made of Titanium (Ti) since it must be corrosion resistant, both against high anodic potential and acidity.

The Porous Transport Layer is one of the most expensive parts of the Polymer Electrolyte Membrane electrolyzer stack. The target price of the Porous Transport Layer is typically less than 2000 $/m₂. Based on future projections of installed Polymer Electrolyte Membrane electrolyzer electrolysis power, an anode PTL market of more than 100M$ is foreseen by 2030.

In view of the costs related to the Porous Transport Layer, a new Porous Transport Layer is disclosed with improved properties to increase the performance and/or the lifetime of a Porous Transport Layer.

The Porous Transport Layer according to the disclosure is provided with a coating layer at the side of the Porous Transport Layer adapted to contact the proton exchange membrane.

In particular, a Porous Transport Layer is disclosed adapted to contact the catalyst layer of the proton exchange membrane at the anode side of the proton exchange membrane.

FIG. 1 schematically shows the build up of a stack for use in a Polymer Electrolyte Membrane electrolyzer with a Porous Transport Layer according to the disclosure. This image is taken from reference JES, 164 (2017) F387.

In FIG. 1, the stack 10 comprises from left to right a first Bipolar Plate 11 to form, in the example of FIG. 1, the anode side for electrolysis. A first Porous Transport Layer 12 is present to electrically connect the first Bipolar Plate 11 with the proton exchange membrane 15, which forms the core of the stack.

This means that the first Porous Transport Layer 12 electrically connects the first Bipolar Plate 11 with the catalyst layer on the anode side of the proton exchange membrane 15.

The stack 10 further comprises a second Bipolar Plate 21 to from, in the example of FIG. 1, the cathode side of the stack. A second Porous Transport Layer 22 is present to electrically connect the second Bipolar Plate 21 with the catalyst layer on the proton exchange membrane 15.

As shown in FIG. 1, the first Porous Transport Layer 12 is provided with a coating layer 13, at the side of the first Porous Transport Layer 12 that is adapted to contact the proton exchange membrane 15.

The coating applied to the Titanium Porous Transport Layer 12 serves as a semi-conductive layer with improved durability against passivation and corrosion. These characteristics are expressed in a performance improvement throughout the lifetime of the electrolyzer stack.

The performance improvement obtained by means of the non-precious metal coating onto a Titanium Porous Transport Layer adding the mentioned typically comprises in a first instance, a lower interfacial resistance between the catalyst on the proton exchange membrane and the Porous Transport Layer, resulting in a lower stack voltage and a higher current density;

A further effect is the presence of a more stable stack voltage during prolonged continuous and/or intermittent use of the stack.

Similarly, the first Porous Transport Layer 22 is provided with a coating layer 23, at the side of the second Porous Transport Layer 22 that is adapted to contact the proton exchange membrane 15.

The first Porous Transport Layer 12 on the anode side is typically made of Titanium (Ti) since it must be corrosion resistant both against high anodic potential and the acidity of the environment wherein the first Porous Transport Layer is used.

According to an embodiment of the disclosure, the first Porous Transport Layer 12 is obtained by applying a non-precious metal coating onto a Titanium Porous Transport Layer according to the prior art.

Known Titanium Porous Transport Layers typically consist of a non-functionalized 3D Titanium structure, such as felt, sintered powder sheets, foams, woven mesh, fine mesh, 3D printed Titanium materials and hole-patterned thin plates.

According to an embodiment of the disclosure, a non-precious metal coating can be provided on a Titanium Porous Transport Layer, by means of heat treatment of the Titanium Porous Transport Layer. The heat treatment can typically range from about 350° Celsius to about 450° Celsius for a time period of about 20-60 minutes. The heat treatment can be done in an air oven.

The effect of such a heat treatment is the formation of a layer of Titanium Oxidelayer (TiOₓ). In this manner, a coating comprising Titanium Oxide can be readily provided on the surface of the Porous Transport Layer.

Instead of a Titanium Oxide coating, other non-precious metal can be used for providing a coating for the Porous Transport Layer.

Some, non-exhaustive examples of (semi-) conductive layers include.

Oxide interlayers: TiOₓ, TaOₓ, NbOₓ and NiCoOₓ;

Metallic interlayers: Ta, Nb, Zr, Ni or mixtures thereof;

A nitride interlayer: TiNₓ TaNₓ, and ZrNx;

Carbide interlayers: TaCₓ, CrCₓ; and

Boride interlayers: TiB₂, TaBₓ, ZrB₂ and CrB₂;

Ion implantation techniques to enrich the original substrate interface with specific ions that reduce passivation and/or corrosion. Alternatively, for the same purpose, the following techniques can be used: physical vapour deposition, chemical vapour deposition or physico-chemical techniques (e.g. paint-thermal decomposition).

All of the above materials have (electro) chemical properties which makes them attractive as prospective coating materials for a Porous Transport Layer. In particular, the above materials are highly resistant to (electro) chemical oxidation. Their resistance to (electro) chemical oxidation is much higher than the resistance of Titanium, and the mentioned materials are also resistant to the attack of halogen anions (Cl−, F−) in the electrolyte. It is further noted that the mentioned materials can be deposited through a PVD method.

### Examples

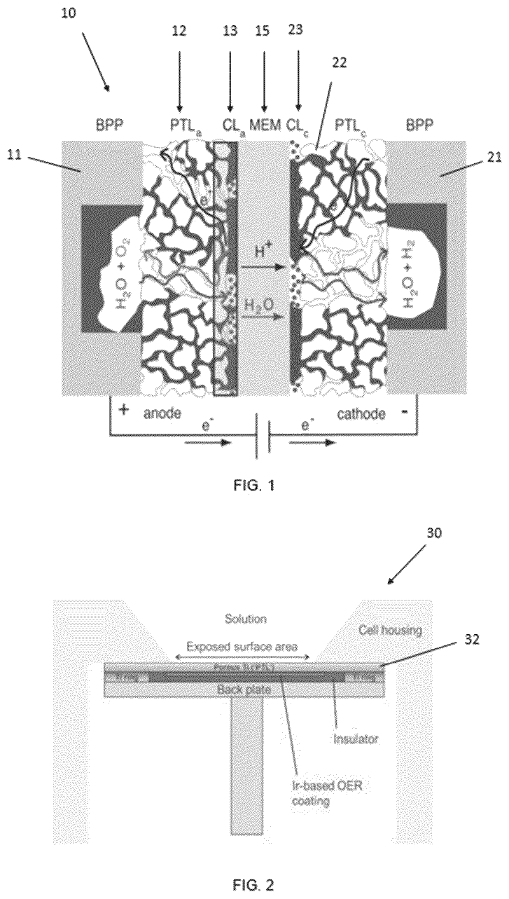

FIG. 2 shows schematically an apparatus 30 that has been developed to allow the testing of Porous Transport Layers 32 and in particular of the effect of adding oxide- and nitride-coatings to such a Porous Transport Layer.

The apparatus 30 allows studying the effect of the Porous Transport Layer 32 independently, i.e., with minimal effect of the catalytic layer. This sort of testing would be is impossible in a functional Polymer Electrolyte Membrane apparatus due to the sandwich structure of stack including the Bipolar Plates 11, 21, the Porous Transport Layers 12, 22 and the catalyst coated proton exchange membrane 15.

In the apparatus 30 according to FIG. 2, standard Porous Transport Layers as supplied by different manufacturers were tested first, without making modifications to the Porous Transport Layers

For instance, a commercially available Porous Transport Layer sold under the tradename ‘Bekaert 60P’ was tested. This Porous Transport Layer comprises Titanium felt, with a 0.2 mm thickness and 60% porosity.

Moreover, Toho WebTi, which is a sintered Titanium Porous Transport Layer, with a 0.04 mm thickness and 40% porosity.

Thereafter, a Porous Transport Layer of Mott Corp was tested, comprising sintered Titanium and a 0.254 mm thickness was pre-treated and tested. From these three materials, Bekaert 60P showed the best performance (highest current density) and its performance was relatively constant.

Next, the Bekaert 60P was heat treated for a period between 10 to 60 minutes in an air oven to a temperature between 400° C. and 530° C.

According to one example, the Bekaert 60P was heat-treated for 25 min at 450° C. in an electric air oven, to create a TiOₓ layer onto the Ti. This resulted in a ˜20% increase in current density.

As an example, the PTL could be coated with Ta ethoxide dissolved in an alcohol. After the alcohol is evaporated off, the PTL can be heat-treated.

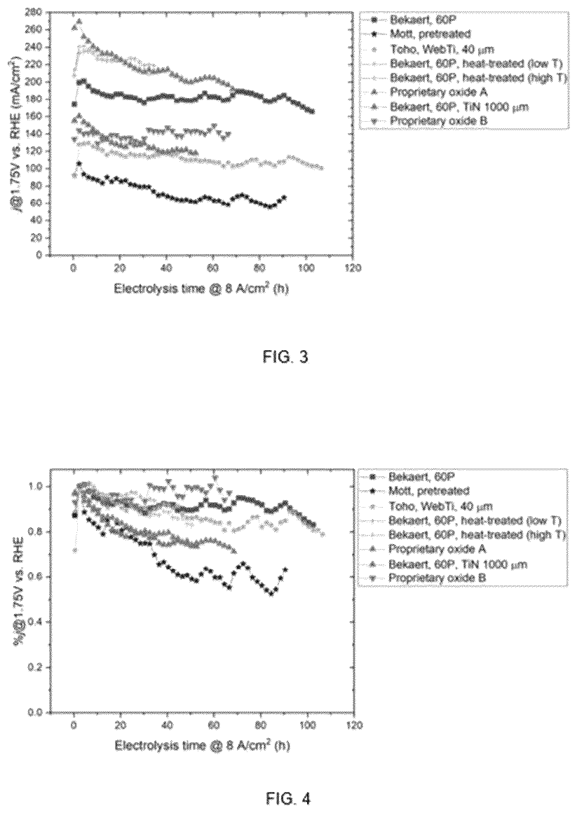

The performance of unmodified and modified Ti PTLs at room temperature, expressed as current density at 1.75 V vs Reversible Hydrogen Electrode is represented in FIG. 3, and expressed relative to the initial performance at 1.75 V vs RHE is represented in FIG. 4.

The mentioned figure shows that the heat treatment resulted in a considerable increase (30-40%) in initial performance (Proprietary oxide A see FIG. 3). The performance did however decrease after about 80 hours of operation (see FIG. 4).

Bekaert 60P was also coated with TiNₓ and TaNₓ coatings (Beakert 60P TIN and Proprietary oxide B, respectively, in FIGS. 3 and 4) using low-temperature reactive sputtering in a nitrogen atmosphere with the respective metal targets. These coatings did not lead to an improvement in initial performance but show promise in terms of stabilizing the performance over time (FIG. 4).

It appears that the improved performance of the Ti PTL with the oxide coatings (TiOₓ and TaOₓ) is caused by an increased hydrophilicity of the surface. A more hydrophilic surface is beneficial for bubble detachment since bubbles are of hydrophobic nature. This improves the gas transport inside the PTL, avoiding bubble hold-up and hence poor fluid distribution.

Borides and carbides, like nitrides, are also expected to provide the required electrochemical protection. These coatings can applied, among others, through borothermic reduction or electrodeposition or reactive sputtering of the metal precursors in a hydrocarbon atmosphere, or carburization or electrodeposition or reactive sputtering of the metal precursors in a boron atmosphere, respectively.

Additionally, they can also be deposited by sputtering with a target of the coating material.

1. A Porous Transport Layer for use in a Polymer Electrolyte Membrane electrolyzer, the Porous Transport Layer comprising a substrate and a coating, wherein the coating comprises a non-precious metal coating.

2. The Porous Transport Layer according to claim 1, wherein the substrate comprises a non-precious metal.

3. The Porous Transport Layer according to claim 1, wherein the coating comprises a metal oxide selected from the group: TiOₓ, TaOₓ, NbOₓ, and NiCoOₓ.

4. The Porous Transport Layer according to claim 1, wherein the coating comprises a metal selected from the group Ta, Nb, Zr and Ni or mixtures thereof.

5. The Porous Transport Layer according to claim 1, wherein the coating comprises a nitride selected from the group comprising TiNₓ. TaNₓ and ZrNx.

6. The Porous Transport Layer according to claim 1, wherein the coating comprises a Carbide selected from the group: TaCₓ, CrCₓ.

7. The Porous Transport Layer according to claim 1, wherein the coating comprises a Boride selected from the group: TiB₂, TaBₓ, ZrB₂ and CrB₂.

8. The Porous Transport Layer according to claim 1, wherein the substrate comprises Titanium (Ti) and the coating comprises Titanium Oxide (TiOₓ).

9. The Porous Transport Layer according to claim 1, wherein the coating is obtained by means of ion implantation techniques to enrich the original substrate interface with ions.

10. An electrochemical system comprising a Polymer Electrolyte Membrane electrolyzer, the Polymer Electrolyte Membrane electrolyzer having a first and a second Bipolar Plate, adapted to function as respectively an anode an a cathode during electrolysis, wherein the Bipolar plates are positioned at opposite sides of a proton exchange membrane and wherein the first Bipolar Plate and the second Bipolar Plate are electrically connected to the proton exchange membrane by means of respectively a first and a second Porous Transport Layer, wherein at least one of the first and second Porous Transport Plates, at the surface adapted to contact the proton exchange membrane, is provided with a non-precious metal coating.

11. The electrochemical system of claim 10, wherein the electrolysis system is a water electrolyzer.

12. A method for obtaining a Porous Transport Layer adapted for use in a Polymer Electrolyte Membrane electrolyzer, the Porous Transport Layer comprising Titanium, wherein the method comprises the step of:
heat treating of the surface of the Porous Transport Plate adapted to contact the proton exchange membrane, to obtain a coating of Titanium Oxide (TiOₓ) at that surface.

13. The method according to claim 12, wherein the step of heat-treating of the surface of the Porous Transport Plate is executed in an air oven.

14. (canceled)
